(19) United States
(12) Patent Application Publication
(10) Pub. No.: US 2007/0037102 A1
(43) Pub. Date: Feb. 15, 2007

(54) System, apparatus, and method for increasing media storage capacity

(75) Inventor: Craig Mowry, Southhampton, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Mediapod LLC, Wilmington, DE (US)

(21) Appl. No.: 11/492,397

(22) Filed: Jul. 24, 2006

Related U.S. Application Data
(60) Provisional application No. 60/701,424, filed on Jul. 22, 2005.
(60) Provisional application No. 60/702,910, filed on Jul. 27, 2005.
(60) Provisional application No. 60/711,345, filed on Aug. 25, 2005.
(60) Provisional application No. 60/710,868, filed on Aug. 25, 2005.
(60) Provisional application No. 60/712,189, filed on Aug. 29, 2005.
(60) Provisional application No. 60/727,538, filed on Oct. 16, 2005.
(60) Provisional application No. 60/732,347, filed on Oct. 31, 2005.
(60) Provisional application No. 60/739,142, filed on Nov. 22, 2005.
(60) Provisional application No. 60/739,881, filed on Nov. 25, 2005.
(60) Provisional application No. 60/750,912, filed on Dec. 15, 2005.

(51) Int. Cl. G03C 1/00

(52) U.S. Cl. 430/495.1

(57) ABSTRACT

A system, an apparatus, or a method is provided for increasing media storage capacity of an image-recording material. A system, an apparatus, or a method is further provided for increasing media storage capacity and for increasing emulsion bearing surface area of an image-recording material.

### CROSS REFERENCE TO RELATED APPLICATIONS

This application is based on and claims the benefit of U.S. Provisional Application Ser. No. 60/701,424, filed on Jul. 22, 2005 and entitled “METHOD, SYSTEM AND APPARATUS FOR INCREASING QUALITY OF FILM CAPTURE,” U.S. Provisional Application Ser. No. 60/702,910, filed on Jul. 27, 2005 and entitled “SYSTEM, METHOD AND APPARATUS FOR CAPTURING AND SCREENING VISUALS FOR MULTIDIMENSIONAL DISPLAY,” U.S. Provisional Application Ser. No. 60/711,345, filed on Aug. 25, 2005 and entitled “SYSTEM, METHOD APPARATUS FOR CAPTURING AND SCREENING VISUALS FOR MULTI-DIMENSIONAL DISPLAY (ADDITIONAL DISCLOSURE),” U.S. Provisional Application Ser. No. 60/710,868, filed on Aug. 25, 2005 and entitled “A METHOD, SYSTEM AND APPARATUS FOR INCREASING QUALITY OF FILM CAPTURE,” U.S. Provisional Application Ser. No. 60/712,189, filed on Aug. 29, 2005 and entitled “A METHOD, SYSTEM AND APPARATUS FOR INCREASING QUALITY AND EFFICIENCY OF FILM CAPTURE,” U.S. Provisional Application Ser. No. 60/727,538, filed on Oct. 16, 2005 and entitled “A METHOD, SYSTEM AND APPARATUS FOR INCREASING QUALITY OF DIGITAL IMAGE CAPTURE,” U.S. Provisional Application Ser. No. 60/732,347, filed on Oct. 31, 2005 and entitled “A METHOD, SYSTEM AND APPARATUS FOR INCREASING QUALITY AND EFFICIENCY OF FILM CAPTURE WITHOUT CHANGE OF FILM MAGAZINE POSITION,” U.S. Provisional Application Ser. No. 60/739,142, filed on Nov. 22, 2005 and entitled “DUAL FOCUS,” U.S. Provisional Application Ser. No. 60/739,881, filed on Nov. 25, 2005 and entitled “SYSTEM AND METHOD FOR VARIABLE KEY FRAME FILM GATE ASSEMBLAGE WITHIN HYBRID CAMERA ENHANCING RESOLUTION WHILE EXPANDING MEDIA EFFICIENCY,” U.S. Provisional Application Ser. No. 60/750,912, filed on Dec. 15, 2005 and entitled “A METHOD, SYSTEM AND APPARATUS FOR INCREASING QUALITY AND EFFICIENCY OF (DIGITAL) FILM CAPTURE,” the contents of which are hereby incorporated by reference in their entirety. This application further incorporates by reference in their entirety, U.S. patent application Ser. No. ______, filed Jun. 21, 2006, entitled: A METHOD, SYSTEM AND APPARATUS FOR EXPOSING IMAGES ON BOTH SIDES OF CELLOID OR OTHER PHOTO SENSITVE BEARING MATERIAL, a U.S. non-provisional application which claims the benefit of U.S. Provisional Application No. 60/692,502, filed Jun. 21, 2005; U.S. patent application Ser. No. 11/447,406, entitled “MULTI-DIMENSIONAL IMAGING SYSTEM AND METHOD,” filed on Jun. 5, 2006, and U.S. patent application Ser. No. 11/408,389, entitled “SYSTEM AND METHOD TO SIMULATE FILM OR OTHER IMAGING MEDIA” and filed on Apr. 20, 2006, the contents of which are hereby incorporated by reference in their entirety.

### FIELD

The present invention relates to a system, an apparatus, or a method for increasing visual information storage capacity of an image storage media. The present invention further relates to a system, an apparatus, or a method for increasing media storage capacity and for increasing emulsion bearing surface area of an image-recording material.

### BACKGROUND

Problems and the issues in the area of film origination and cinematography include the influx of digital origination systems and options for cinema and television, cutting into the film origination market. Film is the preferred artistic medium of many cinematographers, though the drawbacks including the expense of film and processing and the cumbersome and heavy aspects of the equipment. Further drawbacks include the inability to see as definitively as what is being captured as digital and video options can provide, make film an increasingly difficult choice in today's imaging environment. A need exists in the art for more efficient and cost effective systems for use of film stock that combines the advantages of film technology with advances in camera operation and film processing.

### SUMMARY

The present invention relates to a system, an apparatus, or a method for increasing visual information storage capacity of an image storage media. The present invention further relates to a system, an apparatus, or a method for increasing media storage capacity of an image-recording material. The present invention provides a system for increasing media recording capacity and a system for at least doubling the emulsion bearing surface of a film stock. The invention provides a system for utilizing emulsion-bearing image-recording material or film stock that at least doubles the “amount” of emulsion available for recording (capturing) visuals without increasing weight necessarily, as all remains on the same “amount” of celluloid or related emulsion supporting material. Double sided (double emulsion) film stock can be used which has a property that the film stock can be “split” and scanned (digitized) as two distinct “strips” of emulsion supported by other material(s) such as celluloid.

A system for increasing media storage capacity is provided which comprises a container for storing and providing image-recording material to a camera, said image-recording material having a first surface, an opposite surface, a head end and a tail end, and a material repositioning mechanism for delivering the first surface of the image-recording material to at least one camera film gate for exposure and the opposite surface of the image-recording material to the at least one camera film gate for exposure. In one aspect, the material repositioning mechanism rotates the stock longitudinally approximately 180 degrees for delivery of the opposite surface of the image-recording material through the gate for exposure. The head end of the image-recording material can be joined to the tail end of the image-recording material, wherein the joining provides a loop for continual delivery of the material to a camera film gate for exposure of the first surface. The material repositioning mechanism can further comprise a turnable splicing device contacting the stock and disposed between the joined ends of the continuous loop of stock. The material repositioning mechanism can be within the container, within the camera, or within the camera and container. The material repositioning mechanism positions the image-recording material to provide the opposite surface of the image-recording material to the camera for exposure. The material repositioning mechanism can further comprise a turnable splicing device contacting the stock and disposed between the joined ends of the continuous loop of stock. In one aspect, the image-recording material is emulsion-bearing image-recording material. In a further aspect, the image-recording material is photographic film stock.

An apparatus for increasing media storage capacity is provided which comprises a container for storing and providing image-recording material to a camera, said image-recording material having a first surface, an opposite surface, a head end and a tail end, and a material repositioning mechanism for delivering the first surface of the image-recording material to a camera film gate for exposure and the opposite surface of the image-recording material to the camera film gate for exposure.

A method for increasing media storage capacity is provided which comprises providing a container for storing image-recording material, said image-recording material having a first surface, an opposite surface, a head end and a tail end, delivering the image-recording material to a camera for exposure of the first surface, and delivering the image-recording material to the camera, following exposure of the first surface, for exposure of the opposite surface.

A system for increasing visual information storage capacity is provided which comprises an image storage media for recording visual image information, an image receptive component receiving light input and providing visual image information to the storage media, and a visual image information partitioning component to relay at least two identical portions of the visual information to one or more image capture elements of the image receptive component.

An apparatus for increasing visual information storage capacity is provided which comprises an image storage media for recording visual image information, an image receptive component receiving light input and providing visual image information to the storage media, and a visual image information partitioning component to relay at least two identical portions of the visual information to one or more image capture elements of the image receptive component.

A method for increasing visual information storage capacity is provided which comprises receiving light input to an image receptive component, converting the light input to visual image information, and relaying by a visual image information partitioning component at least two identical portions of the visual image information to one or more image capture elements of the image receptive component.

### BRIEF DESCRIPTION OF THE DRAWINGS

FIG. 1 illustrates an exemplary configuration, including a camera, of an exemplary embodiment.

FIG. 2 illustrates a partially exaggerated configuration of a double-sided emulsion film stock.

FIG. 3 illustrates an exemplary configuration of film stock repositioning in the camera.

### DETAILED DESCRIPTION

The present invention relates to a system, an apparatus, or a method for increasing visual information storage capacity of an image storage media. The present invention further relates to a system, an apparatus, or a method for increasing media storage capacity of an image-recording material, and further relates to a system, an apparatus, or a method for increasing media storage capacity and for increasing emulsion bearing surface area of an image-recording material. The present invention at least doubles the “amount” of emulsion available for recording (capturing) visuals without increasing weight necessarily, as all remains on the same “amount” of celluloid or related emulsion supporting material. Double sided (double emulsion) film stock can be used which has a property that the film stock can be “split” and scanned (digitized) as two distinct “strips” of emulsion supported by other material(s) such as celluloid. Film stock can also be maintained as a “single strip” where white or other reflective material behind each emulsion layer my allow processed emulsion to be scanned as flat art, rather than needing to have light projected through the film in scanning.

Conventional film cameras spool unexposed film on one side of a magazine containment, providing that to the film gate of the camera after a “loop” of film emerging from the magazine has been threaded through the camera transport mechanism, and returning the exposed film stock to another side of the magazine after exposure and transport out of the camera. Improvements on the process provided herein occur specifically for the purpose of delivering film media to the camera “twice,” with the intent of exposing specifically prepared motion picture stock, bearing emulsion on both sides, to the camera film gate for exposure. In essence, the film stock is returned to the camera after the full length has been exposed by the camera, for an additional “pass” through the camera mechanism, following a 180 degree repositioning of the film stock allowing the reverse side, also coated with photographic emulsion (separated from the other side by an opaque layer) to record as latent image data to be revealed through photochemical processing. The second pass through the camera may occur in the same direction, should a “continuous loop” configuration of the film stock be provided within the magazine, or in the reverse direction, (returning the stock to the original magazine side once containing unexposed stock) to deliver exposed stock back to where it initially came from in the magazine.

A method, system or apparatus is provided for selectively increasing both quality and quantity of film images captured without significantly altering the capture equipment configuration(s) and without significantly altering the capture media, e.g., film stock. A system for increasing media recording capacity which comprises a container for storing and providing emulsion-bearing image-recording material (such as film stock) to a camera, a strip of said image-recording material having two joined ends, (a “head end” and a “tail end,”) a top surface or “first surface” (known conventionally to be coated with photographic emulsion,) and an opposite surface, (coated with emulsion as well in the preferred configuration,) to provide a loop of the material (such as film stock) for continual delivery of the material to a camera film gate for exposure of the top surface, and a material repositioning aspect of said container for delivering the opposite surface of the material to the camera film gate for exposure.

In one aspect, the system provides a film magazine that may selectively run film to be exposed in both directions, allowing the full length of film to be “reversed” and exposed again (from initial “tail end” to “head end”). However, in the preferred configuration: the film stock, provided in a “disposable” or reusable magazine configuration, would selectively contain a pre-configured “twist” or capability of affecting a 180 degree flip of the film at the “end,” and a continuous loop configuration would link the “end” of the film within the magazine containment with the beginning means to manage the spliced “flip” in the film, such as special rollers, would be selectively included to allow for selectively little or no interruption when the length (such as 400 feet of 16 mm film,) is reached, to allow for the same 400 feet to be re-exposed, however on the “reverse” side, by way of the film twist, purposefully placed at the end/beginning.

In yet another configuration, the twisting or “flipping” of film stock, to provide the reverse side of the film stock to the camera's gate area, (facing the lensing,) would be accomplished with a film gate which itself unlocks and flips 180 degrees, to twist the film and place the reverse side in line with the visuals being related by the camera's lensing. This gate flip could be accomplished manually, or selectively by the camera itself with a slight delay. Additional film management guides, such as rollers, may selectively occur and be employed in managing the film with the “twist” in place, to avoid jamming. Naturally, more cumbersome intervention means to “flip” and reload a reversible magazine could selectively be employed, to achieve the goal of exposing the “other side” of the film stock (which is also coated with emulsion in the present configuration,) though those means defeat the more desired objective of a seamless, or nearly seamless shift from exposing on side of the length of film stock, and then the other, to make the option commercially and logistically feasible.

The general concept is to provide the same length through a film gate intermittently for exposure, allowing both “sides” of the length of stock to be exposed to light relayed through the camera lens. Logistical issues of handling both the return of the stock and the repositioning of it exist. In one aspect, the configuration of the system or apparatus alters the camera configuration not at all, or as little as possible. In a further aspect, the configuration involves reusable film magazines that would be loaded by the manufacturer, not opened by the user or operator of the camera, and returned for processing. The exposed film can be removed by the film processor, not by the user, who typically re-can exposed stock.

The mechanisms of the film delivery and repositioning would make loading and unloading film stock more complex, though not impossible. In the instance of the film camera gate repositioning the stock, by flipping 180 degrees itself, with the stock threaded through it during this repositioning, the magazine would in fact be able to maintain a much more conventional configuration, perhaps only being capable of running the stock in the opposite direction without jamming or other transport issues. Again, other camera component(s) other than the gate, such as rollers and other film transport aspect, could be the means to reposition the stock as well, turning it to allow the opposite side of the celluloid to face the lens.

Within the magazine, once the length of film is reached, whether in a connected or unconnected strip configuration (continuous loop or not,) the further option of manual, semi-automatic, or fully automatic film stock “turning,” (meaning the 180 degree reposition of the film to allow the opposite side to enter the film gate facing the lens,) may include a device as simple as a dial, to allow the user to reposition the stock and selectively engage film management components, (such as rollers,) to maintain the “twist” in a functional way for delivery of the film to the gate without jamming or related issues potentially caused by the film now moving intermittently with a “twist” in essence occurring now prior to the delivery of unexposed emulsion to the gate. This manual or automatic repositioning may required a pause in the transport motion and operation, or not, depending on the complexity of the repositioning apparatus incorporated into the magazine and/or camera.

In a simple configuration, the magazine containment may be repositioned (and reposition-able) once the length of film stock is exposed once, (“head end” to “tail end.”) The magazine would “flip” or pivot itself 180 degrees, front to back (in a panavision film camera format for example, with Arriflex and others having equivalent flipping configuration potential transposing the typical “feed” side with the typical “take up” side of the camera magazine(s.)) This flip, or pivot, would allow the exposed roll to be selectively rethreaded, (returned,) to the camera again, though with the magazine (by operator and/or automatic means) accomplishing the 180 degree “twist” of the film stock (as a function of the magazine,) or with the camera threading and/or function accomplishing the “twist” of the stock, (and subsequent management of same during camera transport through the length of stock,) to allow the film gate to receive the full length of unexposed emulsion occurring on the reverse side (from now exposed emulsion.) Again, meaning from the initial “tail end” back to the initial “head end” of the stock, until both sides are fully, selectively exposed by through the camera gate(s) by the lens image.

The two-sided film stock may be an operable component in the repositioning process as well, with a “hinge” or tiny joint occurring at the splice (or joining area of the two ends,) wherein this joint at the center of the stock allows for a 180 degree flip just like any ball joint or related joining device that allows for such turning. In the instance of a two-direction camera transport, the further option of literal rethreading through the camera exists, including the option of a magazine which is turned to allow the magazine “sides” to invert, front to back or left to right, thus turning the “exposed” side of the magazine now into the “unexposed side,” delivering the stock again to the gate exactly as before after repositioning of the stock is accomplished through the twist or other means to allow the stock to now provide the unexposed “side” to the gate.

A system for increasing imaging media recording capacity is provided which comprises a film camera and film containment magazine working in tandem to allow a length of celluloid bearing photographic emulsion on two sides to be returned to the camera exposure gate from the take up reel of the magazine for a second transport through the camera exposure gate, as a function of the camera, exposing the second side of the celluloid bearing emulsion to a lens image; and further wherein as a function of the camera the celluloid is transported, with emulsion on both sides exposed to the magazine for return of the celluloid to the magazine containment spool that initially contained the celluloid with both sides of emulsion unexposed.

It is to be understood that this invention is not limited to particular methods, apparatus or systems, which can, of course, vary. It is also to be understood that the terminology used herein is for the purpose of describing particular embodiments only, and is not intended to be limiting. As used in this specification and the appended claims, the singular forms “a”, “an” and “the” include plural references unless the content clearly dictates otherwise. Thus, for example, reference to “a container” includes a combination of two or more containers, and the like.

The term “about” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Unless defined otherwise, all technical and scientific terms or terms of art used herein have the same meaning as commonly understood by one of ordinary skill in the art to which the invention pertains. Although any methods or materials similar or equivalent to those described herein can be used in the practice of the present invention, the preferred methods or materials are described herein. In describing and claiming the present invention, the following terminology will be used.

“Recording,” refers, generally, to including an image initially stored as latent image captured within photographic emulsion.

“Imaging device” refers, generally, to any device capable of capturing, sampling and/or digitizing an image. A non-limiting example of an imaging device is a scanner.

“Capture lens image” refers, generally, to a visual gathered by the camera lens and relayed for subsequent image capture(s). Alternatively, a “captured lens image” may refer to light relating to a visual gathered by the camera lens and relayed for subsequent image capture(s).

“Image recording material” refers to any digital recording medium for recording visual images or any transparent or semi-opaque medium, such as celluloid for recording visual images. The “image recording material” can be a digital recording medium for digitally recording visual images. The “image recording material” can be a celluloid recording medium, for example, an emulsion-bearing image-recording material.

“Emulsion-bearing image-recording material” refers to a transparent or semi-opaque medium, such as celluloid, for containing an added photo-sensitive emulsion and maintaining unexposed emulsion in place for proper exposure to a selected stimulus, that is typically light and for containing the processed emulsion for projection, scanning, photographic printing or other imaging purposes. “Emulsion bearing surface” refers, generally to film stock containment media, such as celluloid, where an option exists for coating two surfaces with photographic emulsion, occurring on opposite sides of the media. “Emulsified” means, generally, to include media which has been coated with or contains photographic emulsion, initially unexposed emulsion.

“Camera film gate” refers to the square or rectangular film stabilizing frame that surrounds the image capture zone of a lens image as recorded onto photo sensitive film emulsion, during the resting period of intermittent film transport within a camera.

“Providing a loop for continual delivery of the material to a camera film gate” refers to a connected length of celluloid (material) that is joined at the extreme ends to allow the length to pass again through its entire length after the length reaches it's tail end, as the tail end is joined to the head end.

“Material repositioning mechanism” or “stock repositioning mechanism” refers to a material (such as film) managing and positional affecting assembly, typically comprised of rollers and/or tumblers engaging film sprockets, to guide material (such as film) into a specific direction typically to accommodate specific functions of an apparatus such as a camera, film magazine, photo printer, scanner, projector or other imaging devices that transport film as an aspect of their imaging function.

“Turnable splicing device” refers to a connecting unit that, unlike a typical glue or tape film “splice” incorporates into it's design or material properties the ability to allow at least a 180 degree flip of one side of the material pieces it connects, and maintaining this newly flipped splice position.

“Ball joint” refers to a joint not unlike the human hip, a ball is surrounded by a concave containment housing that preferably extends beyond the equator of the spherical or “ball aspect”, wherein the ball is contained to one thing, and the containment housing to another thing-allowing the two to be connected and yet free to move in multiple directions as a function of the sphere turning within the containment housing.

“Roller mechanism” refers to the rollers within a motion picture camera that guide and affect direction of film stock being transported through the camera.

“Elastic member” refers to a flexible piece, such as rubber, that allows for a range of motion and repositioning without breaking and losing the connection between what this piece may be joined to at two distinct ends or points along its entirety.

“Container” refers to a unit which holds media or other objects for providing them in a specific way as a function of the container and to accommodate function(s) of the devices that are being provided the contained media.

“Motion picture film camera magazine” refers to the light tight container, typically on top of a motion picture magazine, but also occurring behind such cameras often, that has two spools for containing unexposed film media and exposed media respectively on distinct spools, after being engaged to provide and receive such media by a camera functioning in tandem with components of the container, or magazine.

“Film managing components” refers to rollers and sprocketed tumblers typically that transport, maintain tension and taughtness and direct film media as it moves through a camera (or projector, scanner, printer or other film engaging devices).

“Stock repositioning mechanism rotates the stock longitudinally approximately 180 degrees” refers to flipping film stock width wise, not length wise, to turn the other “side” into the facing position previously occupied by the reverse side.

“Optical diversion device” refers to mirroring, lensing and other light affecting means that may alter the pathway of light, including light related to an image.

“Optical diversion device for selectively staggered exposure of emulsion bearing surfaces” refers to image path affecting and altering element(s) that bounce or skew the pathway of light related to a lens image to provide that lens image sequentially to two different sources in an alternating pattern, including to two sides of a single strip of emulsion bearing celluloid. An optical diversion device can provide a full lens image to each respective side of the stock

“Movable gate mechanism” refers to a film gate with the capability of flipping 180 degrees, on its width (not height).

“Exposure of the emulsion bearing surfaces is alternately on opposite sides and/or adjacent sides of the film stock” refers to exposure of a two sided (double emulsioned) strip of celluloid may occur sequentially on the exact opposite side of an emulsion area just exposed, or offset allowing a part of the emulsion on the reverse side not directly opposite to be the next emulsion zone subjected to exposure to light related to an image. The gates are opposite each other, engaging the same specific section of celluloid. In an alternate aspect, the gates can be offset relative to each other

“Stock repositioning mechanism is offset with respect to the lens” refers to a film gate, and it being turned to not face the lens, instead receiving the lens image from image diversion elements, such as optical elements, rather than from directly through the lens.

“Intermittent film advancement speed” refers to film moving through a movie camera moves intermittently, allowing for stable exposure of emulsion before the film again moves to place new emulsion for exposure to light. Typically the speed is 24 frame per second for cinema, for example. Though, the speed is variable based on the operator's choice and objectives.

“Film stock plane” refers to the flat emulsion bearing surface of celluloid based film stock

“Lens plane” refers to a plane intersecting the outer edge of a lens, for example, a spherical lens.

Film stock exposure position is vertical prior to intermittent advancement” refers to the conventional way film stock, or a Panavision format camera system for example, provides film stock, by lowering it vertically from the magazine into the film gate(s)

“A beam splitting device providing a partial image to each side” refers to a term of art, typically an optical prism splitting an image into two or more fragments that can be relayed in two or more directions

“Stock repositioning mechanism provides the tail end of the film stock to the camera” refers to a mechanism to turn the film stock in such a way to allow the reverse side of the stock to pass through the film gate relative to the lens.

A selected camera, like the ARRIFLEX cameras, which require minimal “threading” (unlike Panavision cameras' complex “Mitchell” based threading means,) will be the preferred configuration of the secondary aspect of the present invention which may be selectively employed. This aspect specifically to allow for a dramatic increase in visual quality and resolution, by providing a greatly larger emulsion surface area per visual to be exposed.

Like the old VISTAVISION technology, film would be provided to the film gate horizontally, making the image size only limited “vertically” by the width of the film (gauge size,) such as 16 mm or 35 mm. In the preferred configuration, the film stock, (16 mm in this example though 35 mm is equally exemplary,) the film stock itself would not need sprockets; with the registration technology options today, and transport options, sprockets are cumbersome and wasteful of potential image storing media. The present invention, in the 35 mm configuration, would (importantly) provide an image of a resolution and quality (original) that surpasses any digital originating information capturing means existing, providing the sole option today to capture a visual that only “tomorrow's” digital (or other) technology will have the ability to approach, during image capture.

Film could be selectively provided by a conventionally positioned film magazine, (of the normal or “disposable” configuration disclosed herein, involving reusable magazines loaded and unloaded by the manufacturer only.) Or, film could be provided by a horizontally positioned magazine; meaning 90 degrees (perpendicular) to the normal upright position of film magazines. This to preclude additional film management and positioning needs, (such as rollers turning the film 90 degrees to get it into the horizontal position for the film gate, and then back 90 degrees again after exposure to replace within a vertical film magazine.) This positioning of film stock is not new, though is new in the totality of the present configuration and invention objective(s).

Herein, the providing of film stock to a film gate which is selectively similar in dimension to a rectangular cinema display screen, such as 1.66, or 1.85, (or for the present configuration the width herein will be 2 to 1.) The obvious advantage, being that (in the case of 16 mm film,) the visual may be selectively stored on an emulsion surface 16 mm “high” and as wide as desired, in this instance, 32 mm (or wider, for example.) Though, the width would be entirely selective, by virtue of the (virtually) unlimited left/right media space per visual.

The present invention, in part, thus provides means for generating 35 mm (for example) wide visuals on 16 mm film stock, and visuals in very close dimension to cinema and HD screening dimensions, requiring little adjustment or distortion in the processes of providing final images to these screens. And, as said, 35 mm film stock would provide thee critical means to originate material that surpasses the information capturing/storage means of any digital system, potentially for the foreseeable future, (the emulsion surface area approximately quadrupling the visual information per image stored in the film stock.)

In one aspect, the system of apparatus provides double sided film stock with a film magazine which can automatically reverse it's direction, to allow for a second “run” of the film stock's reverse side through the camera, in the reverse direction, selectively “twisted” by the gate itself or means provided within the magazine and/or film stock placed within the magazine. In the preferred configuration, a “continuous loop” configuration of the film, including a “twist” at the end of the length, with camera means to engage and handle this twist without delay or jamming, would allow for the objective of the invention:

A system or apparatus of the present invention allows for increased emulsion recording area per visual without decreasing the amount of recording “time” per magazine and without adding to the raw media materials/weight therein.

For example, a 16 mm camera allowing for the above options, would provide selectively 400 ft, and thus 10 minutes (appx) of recording media at 24 fps, while also providing visuals selectively approaching the emulsion surface area typical to conventional 35 millimeter camera and film systems. Both weight, size and amount of equipment and media (film) are thus reduced while not reducing (necessarily) image quality. Likewise, the present configuration imposed on a 35 mm film system, would allow for images of the approximate quality (and emulsion recording area) of visuals typical to 65 mm or 70 mm film recording equipment.

Selectively, the “thinner” strips of film resulting for the double sided “splitting” process, may necessarily have to be processed and digitized by specially configured equipment, selectively provided by the film stock (and/or “reusable magazine”) provider. This reusable film magazine is suggested, as it not only provides the technology rights holder with an exclusive on the device and system, but it further handles the complexity of loading and unloading (and processing) the first film stock scenario where selectively a “continuous loop” and selectively “double sided” film stock is involved.

With visual modification options such as the KODAK® LOOK MANAGER SYSTEM, a secondary means is provided pertinent to the present invention, selectively:

A “one light” digitizing of the thinner “split” film stock, (after exposure and processing) might allow for a “standard” and universal digitizing setting. The film might be provided only in digital form for use by the director/cinematographer, who might use digital systems such as the LOOK MANAGER to decide what the “ideal” result from the original filmed images might be. Selectively, these digitally modified images might be the “on line” visuals used for the final edit, OR a discreet system of “match back” involving data related to image (exposure and color) information might be imposed to the original negative (by film frame reference number to automate selectively,) allowing for ONLY the final images of the project selected to be printed “up” (selectively) to maintain quality, and to embody exposure and color modification determined in the digital domain (which are discreetly matched in the physical printing process by way of proven look up table results.) Thus, as an aspect of the present invention and component of the invention system, a post production “look manager” system designed to work in conjunction with a physical film printing means, (directed by the look manager data results by film frame reference (match back) number,) a printing means would have the ability to physically impose color and exposure correction affects to the “light” projected through the original negative (or other stock) in the printing process, with the “look manager” options slaved and based on the means and options this physical printing means and system can provide, for specific and selectively exacting post production work and results, in both the digital and physical (film printing) realms

For example, should the 16 mm format be used to originate under the present invention, a final “print” from the “horizontally exposed” images to a conventional 35 mm film stock (in the conventional direction and format,) might be affected by printing means to alter the exposure level and/or color aspects as the visuals are “printed” onto another film stock, (such as an “internegative” stock.)

The goal being, to end up with a high quality negative of the “larger” gauge size, embodying aesthetic adjustments chosen in the digital domain and also benefiting from the unconventional use of the smaller gauge format (such as 16 mm) to achieve visuals of, or nearing, those typically recorded by the larger gauge size, conventionally.

In total, the present invention provides means to originate with film using “smaller” lighter equipment while resulting in the comparable “original negative” surface area (and resolution and quality,) to larger film gauge bases. Further, the present invention allows for origination with familiar 35 mm systems (including the lensing and housings familiar to the industry,) while resulting in visuals with quality and resolution comparable to “70 mm” originated visuals, thus achieving the goal of surpassing the amount of visual information captured and stored during original photography of any digital system presently available, even if the initial use and screening means does not employ larger than existing digital technology, (such as 2 k or 4 k,) as the “existence” of an original “negative” that future technology can extract vastly more visual information from, (such as 20 k, for example,) renders that project “future ready” and in fact more in synch with the future of digital cinema (and television) than any existing digital origination means may provide.

With the enormous expense of making and releasing films, the availability of an original negative that may provide future applications in synch with the capture devices of the future, increases the potential for that project to be displayed more in the future, should systems upgrade to larger information management/display means. This transition can occur with minimal change to the capture, weight and expense aspects of originating on film.

In yet another configuration, the approach of providing the lens image by way of image diversion means (such as optics, mirroring and/or the like,) to both sides of the stock, would maintain the stock in a vertical position relative to the lens and lens image. However, in such a configuration the stock and film gate(s) would be preferably offset relative to the lens and lens image, (and conventional film gate position,) the offset being for example placing the gate(s) at a perpendicular position relative to the lens and lens image; the film's “edge” facing the lens with the stock itself selectively still pass through the same general camera area as would have been the case had the gate been facing the lens (and placed) conventionally (as with the popular Panavision and Arriflex film cameras.)

As disclosed previous, in relation to the horizontally positioned film stock (allowing for variably wide exposure areas,) in this configuration the vertical stock would be “turned,” for example 90 degrees, and would receive all or part of the lens image on each of it's emulsion coated sides (or surfaces) either in staggered order, (one side being exposed, then the other, then the next intermittent advancement of the film stock by the camera to the next unexposed emulsion zone selectively) or simultaneously. If simultaneously, the lens image would preferably be subjected to a beam splitting device and diverted for recording by the two sides of the offset stock (relative to the lens image) selectively.

In yet another configuration, and with awareness to the film “sides” positions following the first pass (exposure) through the film camera: The camera and magazine may have tandem features and operations related to routing the film from the take-up spool (full with film stock exposed on one side following the first full length pass through the camera) back to the gate for second exposure (of the unexposed side) with further film guiding features specific to the second pass to route the film back to the initial “feed” side of the magazine for “take up” now. Once the stock has passed through the camera it would preferably be halted prior to the “tail end” being taken inside of the magazine, on the “take up” spool end. Thus, that “tail end” may be provided to a selectively placed, specific “slot” or feature that allows the film to travel internally in the camera along a special film management pathway, to deliver it to the film gate again. The advantage herein, is that film need not undergo a “twist” at all, once guided back to the gate and fed down, the opposite side (unexposed) would indeed be the film side entering the gate.

The second challenge and set of specific features under this configuration would involve the film being provided specially out of the camera for return to the initial “feed” side of the magazine, (the side closest to the lens in a Panavision format camera.) The return of the initial “tail end” may be fed into a specific take up feature (opening or slot) within a magazine specific to the present intention, for selectively automatic rethreading and return of the film stock to the feed side, as the length of stock is again run through the gate, exposing the second side.

In this configuration, the camera would run in the same direction mechanically, though would preferably embody additional film guiding and management features to accommodate the “second side” transport, involving the camera “pulling” the film back out of the initial “take up” side of the magazine and returning it to the initial feed side. The film camera would thus continue to run “forward” as before, though the specific film magazine of the present invention would be running “backwards” during the second pass of the stock, to pull the stock from the take up side of the magazine through the camera, and to have the “feed” side turn and actively (selectively) pull the exposed (both sides) stock from the camera, back into the interior of the magazine through the specific features for this function, to be spooled actively back to the feed side until the entire length has been “returned” to that initial side; now with both sides fully exposed after proper use of the system in this configuration. Thus, a normal length of 1,000 foot 35 mm film stock for example, may provide approximately 20 minutes of recording media (emulsion) as opposed to approximately 10 minutes, when passed through the camera component of the present invention at 24 frames per second.

The examples of specific embodiments for carrying out the present invention are offered for illustrative purposes only, and are not intended to limit the scope of the present invention in any way.

In a one embodiment, an increase in the quality of a filmed (e.g., on emulsified material) image that is captured via the photo chemical process, typically employed during the recording of much material in film and television. Preferably, the methods and systems described herein are not limited to motion media, as still photography quality is also vastly increased with regard to image quality, without a need to change the size of equipment, for example to compensate for gauge size of film, or the like.

In a further embodiment, a 16 millimeter (“mm”) film camera (as known in the art) is employed for the capture of visuals, selectively of a quality near, at or beyond that of a conventional 35 mm film camera and film recording means, at image origination. As is apparent to one skilled in the art, any gauge size film and camera may be utilized to benefit from the teachings herein. Moreover, as described in greater detail below, either variable film or other storage medium, a camera, or both are features of the present invention and utilized to avail a user of the benefits taught herein.

In another embodiment, a film camera incorporates optics and film management that enhance typical prior art film cameras. For example, the camera (and film) maximize quality and efficiency by providing a new sequence of events and approaches as each frame of unexposed film (or other emulsified material) moves into a film gate for exposure, by way of light related from a capture lens.

Also, as noted above with regard to currently pending patent applications to the inventor of the present patent application, double-sided emulsion is provided that increases recording ability without increasing the need for additional media by footage, (including film stock,) and associated costs, or to capture secondary images (such as differently focused, exposed or slightly differently positioned capture lens images) for recording on opposite sides of a strip, or joined strips of colloid or other emulsion bearing (or embodying) materials.

Further, a camera is preferably provided that is capable of recording visuals relayed through an optical system onto selectively a three-dimensional, or bubble-like emulsion surface(s). Further, devices are provided to record on both sides of selectably unexpanded “film” within the camera, thereby involving multiple film “gates” or image lay-down zones within the camera.

Moreover, the camera is selectively able to relay altered versions of the lens image (or other captured visual) to each separately exposed side of the emulsified material. This feature is useful for recording on a single side relative to the normal film plane, for example whether the single side is exposed or film repositioned to allow for the reverse side to also be exposed. The altered image versions may have different focusing priorities of the relayed lens image, may have different exposure times or f-stop (iris) settings during exposure, or may have offset lens captures, in case a plurality of lenses is used, of the scene being photographed. Other possible imposed variations of differences selectively imposed on the captured visuals relative to each other are envisioned herein.

Through horizontal recording of visuals on film stock and the option of such images serving only as key frames for enhancing final images selectively, smaller equipment and gauge sized film, photochemical or other recording media is provided to capture enhanced quality visuals, including to selectively capture visuals that embody the same or different versions of captured lens image(s), for selective secondary effects and/or aesthetic options not previously available in the prior art. Without an increase in a size of film stock or equipment, an increased number of visuals and of an increased emulsion surface area may be capture and stored, relative to typical prior art cameras and film stock familiar to the gauge size utilized. Further, additional options include that images recorded within film stock may provide information to affect final images of potentially much more image information, (affecting also quality and resolution,) while still not requiring additional media, (such as motion picture film stock,) in accomplishing the goals (individually or in tandem,) of additional provided overall images or increased image quality within final images derived from the film captures.

Moreover, an entirely new film stock product is provided by teachings herein, as well as equipment used to expose, manage and screen the film stock. This is possible, even though the gauge size and film configuration, whether recording on one or both sides of the film stock, can be unlike conventional film stock. For example, typical sprocket holes, familiar gauge sizes and other conventional aspects of film capture and screening may selectively not be involved in a new film “format” and imaging system, respective devices and methods as disclosed herein. Filmed images destined for digitizing for example, a preferred aspect of the present invention, render sprocketed film transport potentially unnecessary, other electronic means providing both transport and image registration selectably.

Relative to the double emulsified film stock and image capture, subsequent, second “gate” can be provided for exposing the reverse side of the stock, (also bearing emulsion,) which may be a selectively photosensitive or other media capable of recording image information. This may result in the same or selectively altered versions of a single lens (or double lens, offset 3D scenario) onto both sides of a single film strip, selectively simultaneously or exposing in a staggered, or offset manner. Intermittent motion of the film to subsequent frames for exposure might best occur after a “frame” has been exposed on each side of the double sided film, in the double sided configuration, selectively.

In yet another embodiment, a motion picture film camera is provided. The motion picture camera preferably captures visuals through a single, initial capture lens. Within the camera, the lens image may be selectively diverted and or divided (e.g., split), to allow for two separate relayings of all or part of the initial lens image.

In one embodiment, a mirror which may be operable to move, relays the lens image during a period of time selectively to additional lens elements for focusing, particularly in case focusing has not already been accomplished prior to the mirror diversion of the captured lens image/light.

In this embodiment, a first film “gate” to which a image is relayed is positioned offset relative to a typical position of a film gate. In one embodiment, the offset is approximately 90 degrees, or perpendicular to the typical position of a film gate. Thus, the mirror or other mirroring element(s) relays the captured lens image to a second gate during a predefined period of time. This second capture gate may also be offset, relative to a typical film gate position, and may also perpendicular, for example, to a typical prior art film gate position. However, it is possible in an alternative embodiment that the second capture gate is positioned directly opposite of the first offset gate.

The above-described embodiment preferably allows for mirrored or other image diversion elements to provide a full lens image to one gate and then the other for exposure of motion picture film, or other imaging means, (including, for example, charge coupled devices (“CCD”) for electronic capture, or other electronic digitizing elements). In the embodiment using motion picture film, all or a portion of the lens image (e.g., if beam splitting is employed in lieu of full image diversion by mirrors or other elements) is relayed to the two film gates, positioned parallel to each other and selectively placed in direct or close contact. This allows a single strip of motion picture film, or celluloid, which may be provided with double-sided emulsion to travel through a single or modified double gate apparatus, for simultaneous or staggered exposure of the emulsion on the two primary surfaces of the single strip of celluloid or other emulsion coated medium.

Additionally, positioned downstream of the selective image diverter, a CCD may receive intermittently all, or intermittently or continually a portion of the original lens image as well, to allow for video assist viewing, or related similar monitor (electronic) viewing of images being captured for film or other media recording by the present camera and invention. Further, such electronic recording of the lens image may provide image information for additional digital image applications, related to the film captured images; including the option of allowing one of the capture media to provide key frame data at a selectably slower frame rate during capture than the other, whose image data may inform other aspects of final image data allocation and management.

A modified approach to using celluloid film may be employed by the teachings herein. For example, two strips of conventional film may be selectively joined or positioned. The celluloid strips may be thin and separated by an opaque layer or piece celluloid or other material. This minimizes an amount of material and weight necessary for color negative film, and reduces the capture of a maximum number and film frames of a selected gauge size, such as 35 mm.

One advantage of the embodiment that includes a mirrored diversion, as described above, is that a single strip of modified celluloid may capture twice as much overall image information by employing offset film gate(s) to allow for both sides of the celluloid to be exposed from visuals (light) captured through a single lens.

Another advantage is that, in the embodiment including two gates, which may be positioned in parallel or opposite to each other, is that a captured lens image may be selectively relayed as is for recording the unmodified lens image to each of the “gates” or respective sides of the celluloid having different emulsion. Alternatively, the lens image may undergo selective secondary effects or modifications, such as additional optics providing different focusing priorities or other camera setting variations, for relaying the captured lens image multiple times.

In one embodiment, a capture lens is positioned at a selected focal length, for example five feet from the camera plane focusing selection, might relay a visual (e.g., an image) which is relayed for a period of time to a focusing optic unit, preferably within the camera housing, for recording onto film (or other recording means) as a “near focused” visual. Thereafter, the mirror or other relaying devices may relay the lens image to a different focusing optic set up, to allow for that period of time for relaying of the lens image to undergo optical variation by way of a different focusing priority, such as “infinity.” Alternatively, the same optics maybe used that is selectively reset for another setting. This preferably allows for background focus, or background clarity in lieu of foreground clarity. Thus, in such a configuration, a single strip of celluloid might record twelve 35 mm frames of film focused for “five feet” from the camera gate on one side of the film, while twelve frames of film (visuals) are recorded on the other emulsified side of the celluloid set with the infinity focusing priority. Naturally, 24 frames per second, twelve or virtually any other number of visuals per second might be recorded in this way, on both sides of the media having emulsion.

Further, as images are preferably recorded horizontally, the selected emulsion width (and thus overall emulsion area related to each visual captured) need not be the same on both sides of the stock; variably wide film gates and differing optic configurations may allow also for this option. Further, the frame rates between images recorded by one film gate and the other, also need not be identical, depending on the objectives for the image versions captured on the respective sides of the strip of film stock relative to the final images for selectively display.

The example of multiple focus versions maybe used for a special screening effect, such as three-dimensional effect or simply enhanced depth of field effects. Alternatively, the dual-sided film (celluloid) might simple be utilized to increase the material efficiency of the film capture process. Thus, for example, the amount of film stock by foot can be reduced, for example, by half for the same amount of image information captured. One benefit example of this result is a reduced weight of overall media necessary on a shoot, but that is only one example of many potential benefits of the increased efficiency. Other variations between the different relayings of the same lens image may allow for additional effects to be imposed on the visuals, such as different exposure settings, including how long the visuals are exposed to the film or other capture means, or how much light is let through, (iris or f-stop setting) variations, or the like, for selective other post production effects and applications provided by the present invention means and options.

Other configurations and/or embodiments may allow for the offset multiple gates embodiment to be provided as two film gates exposing only one surface of typical motion picture film, as opposed to the embodiment described above including a doublesided emulsion celluloid. In such a configuration, two gates may record, for example, altered versions of the same lens image (such as differently focused) on a single strip of celluloid each gate recording only on every other frame of the film. In post production, digital or other means to automatically delineate between the different recordings on the film or other media of the same lens image and subjected selectively to different secondary applications prior to being recorded in the emulsion. For example, different focusing priorities may be provided by differently set focusing optic(s) that may allow for a single strip of film to provide media allowing for distinct post production options that are applicable and unique to the teachings herein.

The ability to selectively capture the same or altered versions of a single captured lens image selectively on one or more surfaces of single-sided or double sided emulsified celluloid provides unique options that increase recording efficiency and provide additional post production and/or special effects options not otherwise possible using a typical, prior art motion picture camera and system.

Moreover, using a mirror and/or beam splitter to divert a lens image provides for different versions of a single lens image for film emulsion recording, or electronic recording including such options as digital CCD and the like, familiar to digital origination of visuals, such as with the CINE ALTA and other high definition digital cinema systems. Different media working in tandem to capture such versions is another provided option and range of configurations possible within the present invention. Thus, differently exposed or focused versions of the same lens image are recorded either simultaneously or selectively staggered over time. An option of recording visuals on one or both sides of a single strip of specially prepared celluloid (such as provide with double-sided emulsion) is further provided by the selective lens image diversion and dual film gate, as described herein.

Typical prior art projection may not be necessary to acquire an emulsion record of a lens image. For example, a single strip of celluloid which is manufactured to be easily “split” or separated into thinner (e.g., half the normal thickness of motion picture film) halves or sides, selectively separated by another layer such as an opaque protector (to ensure one side's exposure does not affect the other's emulsion or recording) may provide two celluloid records of a single lens image, utilizing no more celluloid that is conventional with normal 24 frames per second with 35 mm filming.

Preferably, emulsion is scanned and digitized for post production and subsequent work. Film origination on thinner, even possibly not projectable strips,(or thinner strips joined to form a more conventional width stock selectably with emulsion on two sides rather than the conventional one,) in no way compromises the integrity of the images captured in the emulsion(s). Thus, if a digital inter-negative approach is planned for a film, for example, the origination on atypical thin halves, such as in the dual-sided film emulsion configuration herein is fine, with the camera negative(s) simply providing a record for digitizing, and “projectable” film versions, (if final projection is not digital) come from subsequent printing of digitized versions of the camera negative(s) onto more conventional and projectable (for example) film print celluloid, such as typical release print stock.

Yet another feature includes a film containment unit familiar to film cameras, such as a “magazine,” which is operable, for example, with conventional movie film cameras. The above-identified double-sided film, or celluloid which features and/or embodies photo-sensitive material on both of its respective surfaces (e.g., front and back) might be configured in a special magazine to allow for use in conventional film cameras.

In a PANA VISION camera, for example, a “disposable,” or selectively reusable magazine might be provided, though this does not preclude a permanent or reloadable magazine application. In the reusable but not user reloadable configuration, for example, 1,000 feet of 35 mm film, may be configured within the magazine housing in a familiar “continual loop” scenario. Of course, one skilled in the art will recognize that any length of film and/or gauge size is applicable. This reusable or reloadable magazine is similar to typical prior art audio cassettes, that when turned over by a user, has tape that is positioned at the beginning once it has run fully through the length contained in the cassette, all tape having run over the magnetic head.

Instead of “replaying,” the magazine described herein allows for “rerecording,” onto the same celluloid or other emulsion or photo sensitive storage strip or media, by way of returning the stock to the same film gate, (in a selectably one gate film camera configuration. However, before “replaying,” either manually or automatically, the film may be turned 180 degrees, (or otherwise manipulated to maintain unexposed emulsion to the gate until both sides are exposed,) to simply allow for the reverse side of photo sensitive “film” or other material to play through the entire length of the unexposed media contained in the magazine. This configuration enables running the entire length of the contained film twice, exposing the reverse side of the special, double emulsified media with two equally or selectively equal photo sensitive “sides” capable of recording latent, or other selected visuals capable of being stored by such media.

In a manual configuration, a compartment on the magazine, such as a pivoting door, may be opened by a user after the film stops or has otherwise reached its full usage length. A pin or other device selectively attached to the end, or other place on the film stock, might be “turned,” selectively with a roller of other stabilizing device lowered to hold and maintain the integrity of the flipped film (or media) and to avoid the essential “loop” or turn just accomplished tram interfering with the proper running of the full length of film again, without jamming, interruption slowing or other undesired issues occurring. Such a “turn” of the film and configuration of the magazine's film contained, for running the length again in this loop configuration, may be accomplished selectively automatically as well, in a variety of known mechanical ways.

Preferably, the magazine is not different from typical prior art magazines in that the film loop which protrudes from the magazine, such as provided in PANAVISION cameras, is provided for easy loading. In the disposable configuration, the entire magazine can be sent for processing, wherein the two-sided film is separated or split after being processed and provided to the user as two processed strips of exposed film, approximately half the thickness of normal, familiar celluloid. Alternatively, the two sided film processed after the splitting, or, the material is immediately digitized to avoid a need to handle the celluloid beyond the processor's plant. In yet another alternative, the “half’ thickness strips of exposed motion picture film may be married to another piece of celluloid or material, in order to return the visuals to the customer on a film stock product similar to that of normal film stock thickness. In this alternative, the media is combined with another transparent film, celluloid, or material thereby using the original camera negative.

In an alternative aspect, the media might be immediately “duped” or copied onto normal thickness film stock, thereby allowing the camera negative information on to typical prior art film stock quickly after processing due to potential issues with the thinner than usual originating media, or film.

Thus, as described above, typical, prior art film cameras using a modified magazine can allow for the typical length of film stock to provide double the recording media using the same amount weight and expense as in typical, prior art media.

The present invention is now further described with reference to the figures, in which like reference numerals represent like elements.

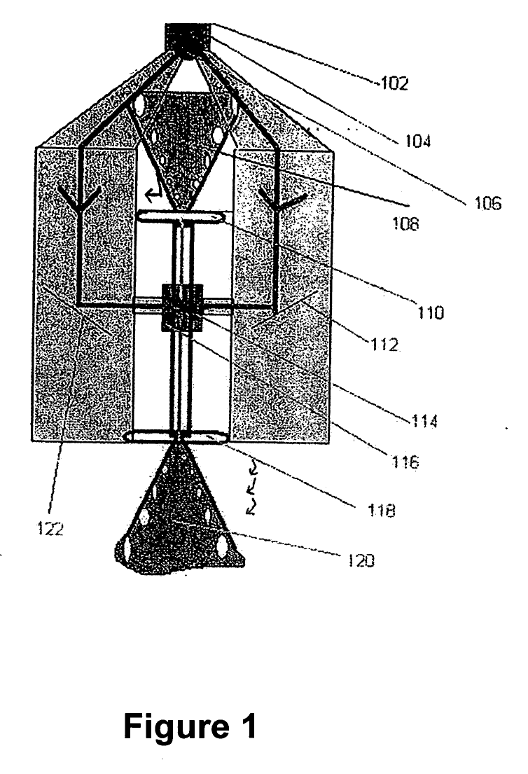

FIG. 1 illustrates an example configuration of an example embodiment, wherein a commonly “top” placed film magazine containment (similar to the PANAFLEX film camera systems) is coupled with a modified film camera threading and multi-gate film transport mechanism. As lens image 102 enters the camera through lens 104, image diversion or beam splitting module 106 provides all or a selected ratio of the lens image's overall light to at least two capture modules, including film gates 114 and 116. Film stock 108 enters the camera in this configuration from a top-of-camera vertical magazine position, though this magazine position is not essential and in fact a horizontal configuration would avoid film repositioning modules' necessity. Though, in the top, vertical magazine configuration of the camera aspect of the system, film stock 108 is turned, or repositioned, selectively 90 degrees, by film management and repositioning module (such as film transport roller(s)) 110, for providing stock 108 to two film gates 114 and 116, occurring on opposite sides of a single film containment or “strip,” of selectively the same thickness and dimension as conventional photographic film media (such as typical 16 mm and 35 mm film stock.)

Image diversion means, such as mirrors 112 and 122, convey respective aspects of the lens image for recording onto stock 108 within gates 114, 116. The film now being provided horizontally enables images to be recorded of variable width, unlike vertically provided motion picture film stock or the like, which is limited by the width of the 35 mm or 16 mm stock, for example. Gates 114,116 preferably have selective image dimension varying means, thereby allowing for selectively image width to be 2:35 to 1, (in one possible screen ratio option,) relative to film stock's 108 available emulsion recording areas height.

Film stock 120 represents a return of the exposed media to the magazine containment, (on top of the camera in this scenario,) after film repositioning module 118 (such as a film transport roller or similar mechanism) returns film stock 120 selectively 90° for proper positioning return to the selectively conventional film stock magazine.

Film stock 108 may, alternatively, be provided and film stock 120 returned in a reversed order. In this alternative, film stock 108 thus providing the film to gates 114, 116 and film stock 120 being the return of exposed stock to the magazine containment, such as in optional configurations.

Moreover, the present dual sided stock 108 configuration may be replaced in yet another alternative by dual gates 114, 116 positioned respectively for exposing two distinct strips of film by two separate distinct, potentially, although not necessarily in separate and distinct magazine containments. In such a configuration image diversion means 112 and 122 would be eliminated or modified to provide aspects of lens image 102 to gates 114, 116, repositioned to expose the separate rolls of film, as the rolls are individually transported into respective gates 114, 116 at the same or different frame rates, depending on the aesthetic goal choice, including, for example, whether key frames are being generated, whether there are multi-focal versions of the lens image being captured, or the like.

Film stock 108, 120 is preferably configured as a single strip of recordable media, including latent image storage within film emulsion, wherein emulsion is provided on both surfaces, and may indeed be a single emulsion bearing celluloid or other strip (or other shape) containment. Stock 108, 120 may also optionally be two thinner such strips combined, selectively separated by a selectively opaque or other divider which may not necessarily provide additional opacity between the emulsion layers, opposite each other.

Further, as indicated in the figures, an electronic capturer, including a video assist and potentially other digital capture device in case such a device not also function in the typical video assist role, may be provided as aspects of the lens image as well, either continually or in a selectively staggered or semi-staggered order relative to the lens image being diverted to other capture devices.

Moreover, film camera gates 114, 116 need not occur directly opposite of the other. Selectively, one gate 114 or 116 may receive the relayed lens image at a distance that is offset from the other gate, allowing for horizontal or vertical gate configurations. Alternatively, in a conventionally fed film configuration, such as in the PANAVISION pull-down, vertical stock camera configuration, gate 114 and/or 116 engages the stock 108 vertically, selectively recording relayed (e.g., diverted) original lens image as conventionally recorded vertical captures. Alternatively, optically turned images selectively can provide for larger images, for horizontal recording involving one or more gates 114, 116, on one side of the stock 108. In yet another alternative, such optically tamed, for recording on vertically provided stock 108, (or horizontally recorded, selectively wide captures by way of variable image size film gates 114, 116,) allow for images of extreme potential resolution and overall information to be recorded horizontally within film stock, (90 degrees offset regular to convention motion picture image capture,) allowing selectively for as many frames per second to be captured as desired as such, though providing for the critical option of fewer than 24 frames per second and as few as one per second or even fewer, to provide key frame resolution and other image information in tandem with a secondary image capture means, such as an 24 fps electronic image capture derived from the same lens image selectively. Therein, one image capture approach may in tandem inform the other, toward final visuals that are improved in quality over typical, prior art film capture.

For example, images captured at 24 frames per second, for example digitally (though not limited by any selected capture and image storage option), may provide relevant information about position of image aspects as they vary between the much more data rich, selectively, filmed (or otherwise captured, potentially an alternate electronic capture means for example,) at a slower rate. Such key frames information allocation within final images, for example, 24 per second final images, may be at least improved or required in the digital inferring, including the options of existing digital morphing means between images, the other image capture data record in one aspect to inform final images in the reallocation of the potentially far more data rich, and including otherwise selective image origination medium aspects, such as color response of film relative to electronic capture, key frame information as its aspects shifted in position as seen through the camera lens, for example, between available recorded key frames. This includes the option of camera configurations involving the creation of high resolution, horizontally recorded filmed images capable of providing, for example, 15 k, 20 k or higher based on emulsion area for imparting to final images, selectively informed by more frequent captures per second provided by a separate selectively less data intensive capturing device receiving aspects of the same lens image selectively. Selectively, even an electronic video assist capturing device may provide such information in certain configurations, allowing existing and conventional film camera lens image relaying means to such a capture device to serve both an “off line” and an “on line” purpose.

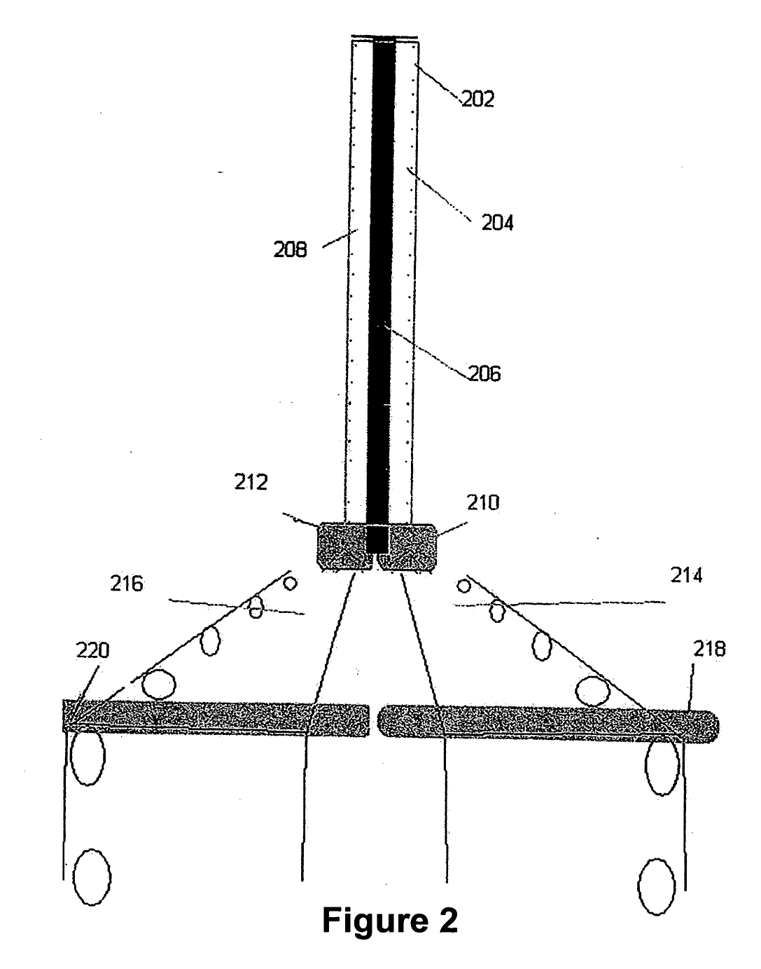

FIG. 2 illustrates a partially exaggerated configuration of a double-sided emulsion film stock. The example shown in FIG. 2 is specific to the stock in the two strips of thinner stock “married” to become a selectively usual thickness of a selected film stock gauge size, as that stock is “split” for separate use, be that photochemical processing, or selectively, digitization of images within the stock already processed. Further, another configuration of the double sided stock innovation would selectively maintain the stock as a single unit, with emulsion having been coated respective to opposite sides; in such a configuration, photochemical processing system aspect and film digitization or other scanning system aspects, would be modified selectively to manage the existence of distinct images on both sides of the emulsion containment strip. In such a configuration, it is potentially necessary that the digitization means be a reflective scanning approach, as with images being maintained on both sides 204 and 208 of the strip, projecting light through would not provide a single discernable image likely. Further, in such a singly maintained strip configuration of the double-sided emulsioned stock, a selectively opaque dividing layer 206 between the processed emulsions may be selectively included, to allow for reflective image scanning, without bleed through of images on the opposite side of said film stock strip.

As exaggerated cross section of film stock 202 is transported in FIG. 2, at a selective stage during management of the film stock after exposure of said stock, the option of film affecting modules 210, 212 dividing the once married strips of stock that together comprise selectively a conventional film stock width; along with selective other aspects that may need be incorporated such as potential opaque dividing layer within film stock 206.

Distinct and divided film stock strips 214 and 216 then are transported for further use by the system, for example by further film transport aspects, including options such as film transport rollers or other means, 218 and 220. These distinct, thinner-than conventional strips of stock are thus now available potentially for digitizing or other image conveying means involving light being transmitted through the processed stock, unlike the scenario where the two emulsions are maintained throughout on one strip, or containment aspect.

Further important is the optional configuration and versatility of the present invention to record within the separate side emulsions of the present invention, selectively different image sizes, one emulsion relative to the other. For example, should a key frame relating to, for example, foreground action captured by the camera lens be primary and more important creatively than other lens information aspects, this key frame may selectively occupy, for example, much more emulsion than for example, smaller (and thus lesser image resolution and quality) film captures potentially captured on the opposite side at the same or a different image capture frame rate. To maintain equal length of the emulsions relative to their captures of the lens image information, selectively a key frame capture may, for example, occupy three times as wide and emulsion length as, for example, differently focused or optically affected aspects of the lens image capture being relayed to emulsion on the opposite side of the strip, during capture.

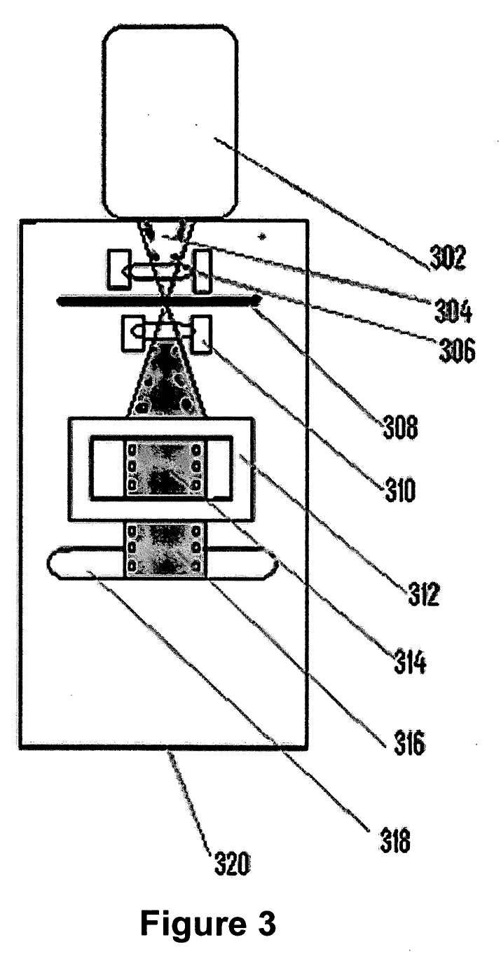

FIG. 3 illustrates an exemplary configuration of film stock repositioning in the camera. This repositioning may occur in the film magazine as a function of that component, in the camera as illustrated, or as a tandem function of both camera aspects (within the camera housing or in the magazine containment,) but the effect is the same: The camera film gate effectively receives the reverse side of the film stock.

Regardless of whether the magazine is operating under a “continuous loop” configuration delivery to the gate, (or whether the magazine has been “flipped,” placing the take up spool end in the position of the initial feed spool end (of the magazine containment,) or if they magazine as disclosed has the capacity to run in reverse with camera and/or magazine threading means to re-deliver the stock to the gate for a second pass and replace it to the feed spool end of the magazine,) the goal herein is to provide the reverse side of the double emulsioned (emulsion coating on both film stock sides,) film stock to the gate.

FIG. 3 shows a double sided 35 mm film gate, (though gauge size is not a limiting aspect,) wherein the stock has been repositioned for horizontal exposure within this gate. This gate can be a single sided gate, with the stock re-delivered to the gate as disclosed herein. In a further aspect, as illustrated, the gate can be a double gate system, (with the gates either directly opposite each other, or offset relative to each other,) for selective staggered exposure of both sides, to allow full exposure of both sides once the length is reached fully, once (placing the full length, as with conventional magazine scenarios, onto the take up spool of the film magazine containment.)

FIG. 3 illustrates magazine containment 302, providing film stock from the feed side, (front end closest to the lens in a Panavision camera configuration for example,) to film gate 312. In a first “pass” of the film stock 304 through gate 312, the film stock repositioning assembly, comprised of example components here 306, 308 and 310, may not be engaged, allowing the film stock to pass without longitudinal “twisting” as the stock enters gate 312. These components may, for example, be a series of film managing rollers and/or sprocket engaging rollers and/or tumblers, spaced selectively to allow for optimum management and affecting of the film flipping “twist” of the present invention.

Once the film has passed once entirely through the gate, in this configuration, a continuous loop configuration of the stock, (the ends splice,) allows beginning of the stock 304 to again be returned to the gate for re-exposure. However, in this illustrated configuration, prior to such, the film gate 312 releases, (or “opens,”) to allow the stock to turn without film gate restriction as film stock repositioning components 304, 306 and 308, engage in tandem to contact and “twist” the film stock, maintaining the twist entirely between these components, allowing the twist to continue as such without interruption of a (for example) 24 frames per second intermittent transport of the stock, for conventional exposure of the stock through the gate, 312.

The film gate 312 may “close” or reengage to manage the stock after such a twist, in order to provide the second side of emulsion as a taught, flat and stable plane for exposure to the lens image provided.

The film stock, after exposure of the second side 316, continues through the camera for selective conventional camera threading (including roller 318 potentially, for example,) and transport toward the take up spool within the magazine containment, 302.

As image diversion means are illustrated in FIGS. 1, 2, and 3, the present invention is not limited by the illustrated gate position herein, which is in the direct path of the lens light (and thus lens image being conveyed optically.) The “twist” and gate(s) involved in the camera configuration may occur in a virtually unlimited number of positions, should the configuration involved one or more diverted portions of the lens image prior to relaying same to film emulsion(s) for recording.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

What is claimed:

1. A system for increasing media storage capacity comprising,
a container for storing and providing image-recording material to a camera, said image-recording material having a first surface, an opposite surface, a head end and a tail end, and
a material repositioning mechanism for delivering the first surface of the image-recording material to at least one camera film gate for exposure and the opposite surface of the image-recording material to the at least one camera film gate for exposure.

2. The system of claim 1 wherein the image-recording material is emulsion-bearing image-recording material.

3. The system of claim 2 wherein the image-recording material is photographic film stock.

4. The system of claim 1 wherein the material repositioning mechanism rotates the image-recording material longitudinally approximately 180 degrees for delivery of the opposite surface of the image-recording material through the gate for exposure.

5. The system of claim 4 further comprising the head end joined to the tail end, said joining providing a loop for continual delivery of the image-recording material to a camera film gate for exposure of the first surface.

6. The system of claim 4 wherein the material repositioning mechanism further comprising a turnable splicing device contacting the image-recording material and disposed between the joined ends of the continuous loop of the image-recording material.

7. The system of claim 6 wherein the turnable splicing mechanism further comprises a ball joint.

8. The system of claim 6 wherein the turnable splicing mechanism further comprises a roller mechanism.

9. The system of claim 6 wherein the turnable splicing mechanism further comprises an elastic member.

10. The system of claim 1 wherein the image-recording material further comprises photographic emulsion on at least the first surface and the opposite surface.

11. The system of claim 1 wherein the container is a motion picture film camera magazine.

12. The system of claim 1 wherein the film gate selectively repositions the image-recording material for exposure of emulsion on the opposite surface of the image-recording material.

13. The system of claim 1 wherein the container further comprises film managing components for providing the image-recording material to the film gate of the camera without interruption of the film transport function of the camera.

14. The system of claim 1 wherein the container is a reusable film magazine loaded with the image-recording material prior to delivery to a camera operator.

15. The system of claim 14 wherein the reusable film magazine is loaded with the image-recording material by a manufacturer.

16. The system of claim 14 wherein the container is unloaded prior to processing the image-recording material by a manufacturer.

17. The system of claim 1 wherein the material repositioning mechanism is within the container.

18. The system of claim 17 wherein the material repositioning mechanism positions the container to provide the opposite surface of the image-recording material to the camera for exposure.

19. The system of claim 1 wherein the material repositioning mechanism is within the camera.

20. The system of claim 1 wherein the material repositioning mechanism is within the camera and the container.

21. The system of claim 19 further comprising a movable gate mechanism to rotate the image-recording material and provide the opposite surface of the image-recording material for exposure.

22. The system of claim 19 wherein the stock repositioning mechanism further comprises an optical diversion device for selectively staggered exposure of emulsion bearing surfaces.

23. The system of claim 22 wherein the exposure of the emulsion bearing surfaces is on opposite sides of the image-recording material.

24. The system of claim 22 wherein the exposure of the emulsion bearing surfaces is alternately on opposite sides and adjacent sides of the image-recording material.

25. The system of claim 21 wherein the gates are opposite relative to each other.

26. The system of claim 22 wherein the stock repositioning mechanism is offset with respect to the lens.

27. The system of claim 22 wherein the gates are offset relative to each other.

28. The system of claim 22 wherein an intermittent film advancement speed is reduced.

29. The system of claim 28 wherein a camera frame rate is reduced.

30. The system of claim 22 wherein a film stock plane is perpendicular to a lens plane.

31. The system of claim 22 wherein image-recording material exposure is vertical prior to intermittent advancement.

32. The system of claim 22 further comprising an optical diversion device providing a majority of the light related to a lens image to each respective side of the image-recording material

33. The system of claim 22 further comprising a beam splitting device providing a partial image to each side.

34. The system of claim 17 wherein the material repositioning mechanism within the container rotates the image-recording material selectively 180 degrees prior to the image-recording material being returned again to the camera, wherein the material repositioning mechanism provides the opposite surface of the image-recording material to the camera for exposure.

35. The system of claim 34 wherein an emulsion-bearing surface of the image-recording material is at least doubled.

36. The system of claim 34 wherein the material repositioning mechanism rotates the image-recording material longitudinally 180 degrees.

37. The system of claim 17 wherein the material repositioning mechanism repositions the image-recording material within the container to provide the opposite surface of the image-recording material to the camera for exposure.

38. The system of claim 37 wherein the material repositioning mechanism provides the tail end of the image-recording material to the camera.

39. The system of claim 34 wherein the material repositioning mechanism reverses the transport direction of the image-recording material.

40. An apparatus for increasing media storage capacity comprising,
a container for storing and providing image-recording material to a camera, said image-recording material having a first surface, an opposite surface, a head end and a tail end, and
a material repositioning mechanism for delivering the first surface of the image-recording material to a camera film gate for exposure and the opposite surface of the image-recording material to the camera film gate for exposure.

41. The apparatus of claim 40 wherein the image-recording material is emulsion-bearing image-recording material.

42. The apparatus of claim 41 wherein the image-recording material is photographic film stock.

43. The apparatus of claim 40 wherein the material repositioning mechanism rotates the image-recording material longitudinally approximately 180 degrees for delivery of the opposite surface of the image-recording material through the gate for exposure.

44. The apparatus of claim 43 further comprising the head end joined to the tail end, said joining providing a loop for continual delivery of the image-recording material to a camera film gate for exposure of the first surface.

45. The apparatus of claim 43 wherein the material repositioning mechanism further comprising a turnable splicing device contacting the stock and disposed between the joined ends of the continuous loop of image-recording material.

46. A method for increasing media storage capacity comprising
providing a container for storing image-recording material, said image-recording material having a first surface, an opposite surface, a head end and a tail end,
delivering the image-recording material to a camera for exposure of the first surface, and
delivering the image-recording material to the camera, following exposure of the first surface, for exposure of the opposite surface.

47. The method of claim 46 further comprising contacting the image-recording material with a material repositioning mechanism for delivering the image-recording material to the camera for exposure of the first surface and for exposure of the opposite surface.

48. The method of claim 46 wherein the image-recording material is delivered to a camera film gate within the camera.

49. The method of claim 46 wherein the image-recording material is emulsion-bearing image-recording material.

50. The method of claim 49 wherein the image-recording material is photographic film stock.

51. The method of claim 50 wherein the camera is operable to provide the stock from the take up spool to the film gate for exposure of the opposite surface, the camera further providing the stock, following exposure of the opposite surface, for respooling onto the feed spool, such that selectively all of the stock will occur on the feed spool after exposure of the entire length of the opposite surface of the stock.

52. The method of claim 48 further comprising rotating the image-recording material longitudinally approximately 180 degrees by the material repositioning mechanism for delivery of the opposite surface of the image-recording material through the gate for exposure.

53. The method of claim 52 further comprising joining the head end to the tail end of the image-recording material, said joining providing a loop for continual delivery of the image-recording material to the camera film gate for exposure of the first surface.

54. The method of claim 52 wherein the material repositioning mechanism further comprising a turnable splicing device contacting the image-recording material and disposed between the joined ends of the continuous loop of stock.

55. The method of claim 54 wherein the turnable splicing mechanism further comprises a ball joint.

56. The method of claim 54 wherein the turnable splicing mechanism further comprises a roller mechanism.

57. The method of claim 54 wherein the turnable splicing mechanism further comprises an elastic member.

58. The method of claim 49 wherein the image-recording material further comprises photographic emulsion on at least the first surface and the opposite surface.

59. The method of claim 50 wherein the container is a motion picture film camera magazine.

60. The method of claim 59 wherein the film camera magazine further comprises spools for containing and turning the film stock, the spools including a feed spool on which unexposed stock is initially provided and a take up spool where the stock is provided to as a function of the magazine and camera, as the first surface is exposed by the camera.

61. The method of claim 60 wherein the film camera magazine is operable to provide the stock from the take up spool to the film gate for exposure of the opposite surface, the magazine further providing the stock, following exposure of the opposite surface, for respooling onto the feed spool, wherein all of the stock will occur on the feed spool after exposure of the entire length of the opposite surface of the stock.

62. The method of claim 60 wherein the camera and magazine are operable to provide the stock from the take up spool to the film gate for exposure of the opposite surface, the camera and magazine further providing the stock, following exposure of the opposite surface, for respooling onto the feed spool, such that selectively all of the stock will occur on the feed spool after exposure of the entire length of the opposite surface of the stock.

63. The method of claim 46 further comprising contacting the image-recording material with the film gate, and repositioning the image-recording material for exposure of emulsion on the opposite surface of the image-recording material.

64. The method of claim 46 further comprises providing the image-recording material to the film gate of the camera without interruption of the film transport function of the camera through film managing components in the container.

65. The method of claim 46 wherein the container is opened and the image-recording material unloaded by a selected processing facility following exposure.

66. The method of claim 65 wherein the container is a reusable film magazine, said reusable film magazine loaded with the image-recording material by a manufacturer.

67. The method of claim 65 wherein the container is unloaded prior to processing the image-recording material by a manufacturer.

68. The method of claim 46 wherein the material repositioning mechanism is within the container.

69. The method of claim 68 wherein the material repositioning mechanism positions the image-recording material within the container to provide the opposite surface of the image-recording material to the camera for exposure.

70. The method of claim 46 wherein the material repositioning mechanism is within the camera.

71. The method of claim 46 wherein material repositioning mechanism is within the camera and the container.

72. The method of claim 70 further comprising rotating the image-recording material by a movable gate mechanism to and providing an opposite surface of the image-recording material for exposure.

73. The method of claim 70 further comprising staggering exposure of emulsion bearing surfaces by an optical diversion device within the material repositioning mechanism.

74. The method of claim 73 further comprising exposing the emulsion bearing surfaces on alternately on the first surface and the opposite surface of the image-recording material.

75. The method of claim 73 further comprising exposing the emulsion bearing surfaces alternately on the first surface and the opposite surface and adjacent surfaces of the image-recording material.

76. The method of claim 67 wherein the gates are opposite relative to each other.

77. The method of claim 73 wherein the stock repositioning mechanism is offset with respect to the lens.

78. The method of claim 73 wherein the gates are offset relative to each other.

79. The method of claim 73 wherein an intermittent film advancement speed is reduced.

80. The method of claim 79 wherein a camera frame rate is reduced.

81. The method of claim 73 wherein a image-recording material plane is perpendicular to a lens plane.

82. The method of claim 73 wherein image-recording material exposure is vertical prior to intermittent advancement.

83. The method of claim 73 further comprising providing a full lens image through an optical diversion device to each respective side of the image-recording material.

84. The method of claim 68 further comprising providing a partial image to each side by a beam splitting device.

85. The method of claim 68 further comprising rotating the image-recording material selectively 180 degrees prior to the image-recording material being returned again to the camera, providing the opposite surface of the image-recording material to the camera for exposure.

86. The method of claim 85 wherein an emulsion-bearing surface of the image-recording material is at least doubled.

87. The method of claim 85 wherein the material repositioning mechanism rotates the image-recording material longitudinally 180 degrees.

88. The method of claim 68 wherein the material repositioning mechanism repositions the image-recording material within the container to provide the opposite surface of the image-recording material to the camera for exposure.

89. The method of claim 88 wherein the material repositioning mechanism provides the tail end of the image-recording material to the camera.

90. The method of claim 85 wherein the material repositioning mechanism reverses the transport direction of the image-recording material.

91. A system for increasing visual information storage capacity comprising,
an image storage media for recording visual image information,
an image receptive component receiving light input and providing visual image information to the storage media, and
a visual image information partitioning component to relay at least two identical portions of the visual information to one or more image capture elements of the image receptive component.

92. The system of claim 91 wherein the image receptive component is a camera.

93. The system of claim 91 wherein visual image information related to the image is relayed through a single lens.

94. The system of claim 91 wherein the image receptive component is a digital camera or film camera.

95. The system of claim 91 wherein the visual image information is electromagnetic, visible light, infrared light, ultraviolet light, x-ray, nuclear magnetic, or digital image information.

96. An apparatus for increasing visual information storage capacity comprising,
an image storage media for recording visual image information,
an image receptive component receiving light input and providing visual image information to the storage media, and
a visual image information partitioning component to relay at least two identical portions of the visual information to one or more image capture elements of the image receptive component.

97. The apparatus of claim 96 wherein the image receptive component is a camera.

98. The apparatus of claim 96 wherein visual image information related to the image is relayed through a single lens.

99. The apparatus of claim 96 wherein the image receptive component is a digital camera or film camera.

100. The apparatus of claim 96 wherein the visual image information is electromagnetic, visible light, infrared light, ultraviolet light, x-ray, nuclear magnetic, or digital image information.

101. A method for increasing visual information storage capacity comprising
receiving light input to an image receptive component,
converting the light input to visual image information, and
relaying by a visual image information partitioning component at least two identical portions of the visual image information to one or more image capture elements of the image receptive component.

102. The method of claim 101 wherein the image receptive component is a camera.

103. The method of claim 101 wherein visual image information related to the image is relayed through a single lens.

104. The method of claim 101 wherein the image receptive component is a digital camera or film camera.

105. The method of claim 101 wherein the visual image information is electromagnetic, visible light, infrared light, ultraviolet light, x-ray, nuclear magnetic, or digital image information.
